(19) United States
(12) Patent Application Publication
(10) Pub. No.: US 2026/0088607 A1
(43) Pub. Date: Mar. 26, 2026

(54) POWER SUPPLY SYSTEM

(71) Applicant: ISUZU MOTORS LIMITED, Yokohama-shi (JP)

(72) Inventors: Taro YOSHIOKA, Fujisawa-shi (JP); Hiroaki WATANABE, Fujisawa-shi (JP)

(21) Appl. No.: 19/316,168

(22) Filed: Sep. 2, 2025

(30) Foreign Application Priority Data
Sep. 20, 2024 (JP) 2024-163389

(51) Int. Cl. H02H 7/20; B60L 58/12; B60L 58/20; H02J 1/08; H02J 1/10

(52) U.S. Cl. CPC H02H 7/20; B60L 58/12; B60L 58/20; H02J 1/082; H02J 1/102; B60L 2210/10; B60L 2240/545; B60L 2260/32

(57) ABSTRACT

A power supply system includes: a first energy storage device that outputs electric power at a reference voltage; a first voltage converter that converts the reference voltage to a first voltage lower than the reference voltage; a second voltage converter that converts the reference voltage to a second voltage lower than both the reference voltage and the first voltage; a second energy storage device that stores the electric power converted by the second voltage converter; a third voltage converter that further converts the first voltage output from the first voltage converter to the second voltage; and a fourth voltage converter that further converts the second voltage to the first voltage on the basis of the electric power converted to the second voltage by the second voltage converter and the electric power stored in the second energy storage device.

### CROSS-REFERENCE TO RELATED APPLICATIONS

The present application claims priority to Japanese Patent Application number 2024-163389, filed on Sep. 20, 2024, contents of which are incorporated herein by reference in its entirety.

### BACKGROUND OF THE INVENTION

The present disclosure relates to a power supply system. A conventional power supply device supplies electric power, obtained by converting a voltage from DC 100 V to DC 12 V, to an operation system of a vehicle and supplies electric power, obtained by converting a voltage from DC 100 V to DC 24 V, to a sensor system of the vehicle (for example, Japanese Unexamined Patent Application Publication No. 2020-156230).

In a case where two different voltages are used to operate devices in the vehicle, it is required to provide redundancy in the power source for each of the two different voltages in order to operate the vehicle even when a failure such as a power failure occurs. However, this approach results in problems such as an increase in the weight of the power supply device and an increase in the cost associated with the power supply device.

### BRIEF SUMMARY OF THE INVENTION

The present disclosure has been made in view of these points, and its object is to supply electric power at two different voltages when a failure occurs, without providing redundancy in the power source.

A power supply system according to the present disclosure includes: a first energy storage device that outputs electric power at a reference voltage; a first voltage converter that converts the reference voltage to a first voltage that is lower than the reference voltage; a second voltage converter that converts the reference voltage to a second voltage that is lower than both the reference voltage and the first voltage; a second energy storage device that stores the electric power converted by the second voltage converter; a third voltage converter that further converts the first voltage output from the first voltage converter to the second voltage; and a fourth voltage converter that further converts the second voltage to the first voltage on the basis of the electric power converted to the second voltage by the second voltage converter and the electric power stored in the second energy storage device.

### BRIEF DESCRIPTION OF THE DRAWINGS

FIG. 1 is a diagram illustrating an outline of a vehicle S according to the present embodiment.

FIG. 2 is a diagram illustrating a configuration of a power supply system 10 in which a first voltage converter 21 has failed.

FIG. 3 is a diagram illustrating a configuration of the power supply system 10 in which a second voltage converter 22 has failed.

FIG. 4 is a diagram showing a vehicle S that changes the voltage of electric power to be supplied in response to a power failure.

FIG. 5 is a diagram illustrating a configuration of the power supply system 10 in which the first voltage converter 21 illustrated in FIG. 4 has failed.

FIG. 6 is a diagram showing a voltage of electric power supplied to a first device 1b.

FIG. 7 is a diagram illustrating a configuration of the power supply system 10 in which the second voltage converter 22 illustrated in FIG. 4 has failed.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Overview of a Vehicle S

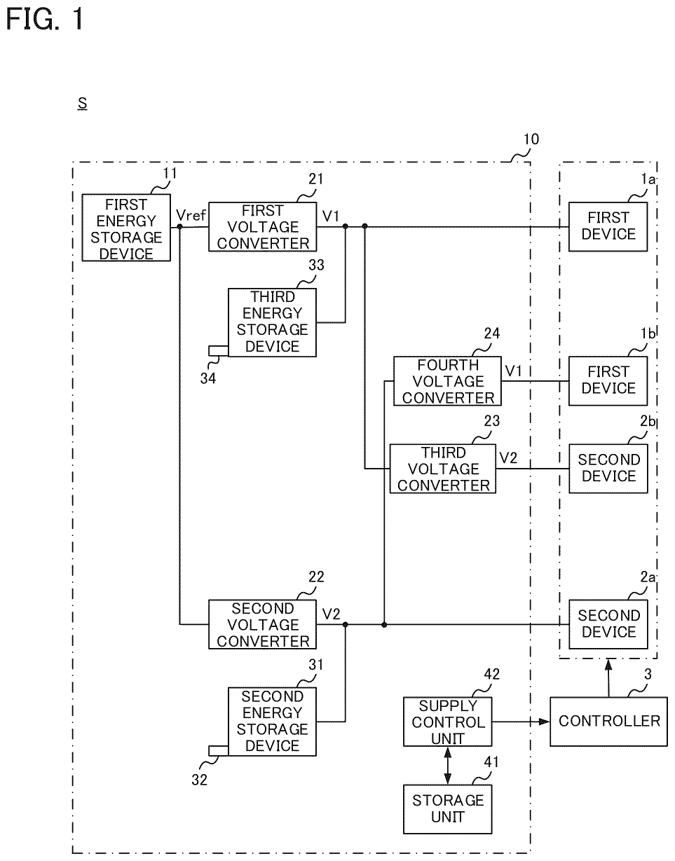

FIG. 1 is a diagram illustrating an overview of a vehicle S according to the present embodiment. The vehicle S illustrated in FIG. 1 includes a plurality of first devices 1 (a first device 1a and a first device 1b illustrated in FIG. 1), a plurality of second devices 2 (a second device 2a and a second device 2b illustrated in FIG. 1), a controller 3, and a power supply system 10. The vehicle S is a vehicle with a function of supplying electric power corresponding to a power supply voltage of each of a plurality of auxiliary devices included in the vehicle S, and is, for example, an EV (Electric Vehicle) such as a BEV (Battery Electric Vehicle), an HV (Hybrid Vehicle), or an FCV (Fuel Cell Vehicle). The plurality of auxiliary devices are, for example, the plurality of first devices 1 and the plurality of second devices 2, and the power supply voltage is, for example, 12 V, 24 V, or 48 V. In the vehicle S illustrated in FIG. 1, the power supply system 10 supplies electric power corresponding to the power supply voltage of the first devices 1 to the first devices 1, and supplies electric power corresponding to the power supply voltage of the second devices 2 to the second devices 2.

Each first device 1 is a device that operates at voltages within a first range, and is, for example, a device (as one example, a steering actuator) used for driving the vehicle S among a plurality of devices included in the vehicle S. The first range is a range that includes 24 V, and is, for example, 20 V or more and less than 32 V. Each second device 2 is a device that operates at voltages within a second range, and is, for example, one of a plurality of devices included in the vehicle S that is used to control the driving operation of the vehicle S (for example, an ECU (Electronic Control Unit) that controls the steering actuator). The second range is a range that includes 12 V, and is, for example, 10 V or more and less than 20 V.

The first devices 1a and 1b have the same function, and the second devices 2a and 2b have the same function. The first device 1a, the first device 1b, the second device 2a, and the second device 2b are simultaneously supplied with electric power from the power supply system 10. As described above, by providing the vehicle S with two identical devices and supplying electric power simultaneously to these devices, the vehicle S can switch to the other device (e.g., the first device 1b) even if one of the devices (e.g., the first device 1a) becomes unavailable. In addition, since electric power is being supplied to the other device, the switching time can be shortened.

The controller 3 is a device including a VCU (Vehicle Control Unit), for example, and is a device that controls the vehicle S. For example, the controller 3 acquires, via a VCI (Vehicle Communication Interface), device information indicating a device to which the supply of electric power is stopped, and switches to the other device corresponding to that device. Specifically, when the supply of electric power to the first device 1a is stopped while the first device 1a is in use, the controller 3 switches to use the first device 1b. Additionally, for example, the controller 3 acquires, from the power supply system 10, instruction information for instructing the execution or disabling autonomous driving of the vehicle S, and controls the vehicle S on the basis of an instruction included in the instruction information.

The power supply system 10 is a system for supplying electric power to each device included in the vehicle S. For example, the power supply system 10 supplies electric power at a first voltage (for example, 24 V) within the first range to the first device 1a and the first device 1b, and supplies electric power at a second voltage (for example, 12 V) within the second range to the second device 2a and the second device 2b. For example, when a power failure occurs in the vehicle S, the power supply system 10 outputs instruction information including an instruction to disable autonomous driving to the controller 3, thereby placing the vehicle S in a safe state. Specifically, by outputting the instruction information to the controller 3, the power supply system 10 may switch the vehicle S from autonomous driving to manual driving, or stop the vehicle S on the shoulder of the road and maintain the stopped state. As one example, the power supply failure may be a failure of a voltage converter (DC-DC converter) that converts the voltage (reference voltage) of the power source to the first voltage or the second voltage.

The power supply system 10 includes a plurality of power sources and has a configuration in which electric power can be supplied to each device of the vehicle S for each power source (so-called providing redundancy in power source), so that even when a failure occurs in one power source, electric power can be supplied from another power source different from the one power source. However, since the vehicle S supplies electric power at the first voltage and electric power at the second voltage, providing redundancy in power source for each voltage increases the weight and cost of the power supply device. Therefore, the power supply system 10 further includes a voltage converter (third voltage converter 23) that converts the first voltage to the second voltage, and a voltage converter (fourth voltage converter 24) that converts the second voltage to the first voltage.

With the above configuration, the power supply system 10 can generate electric power at the first voltage from electric power at the second voltage even when a power failure related to the electric power at the first voltage occurs. In addition, the power supply system 10 can generate electric power at the second voltage from the electric power at the first voltage even when a power failure related to the electric power at the second voltage occurs. As a result, the power supply system 10 is capable of supplying electric power at both the first voltage and the second voltage, even if a power failure occurs, without having a redundant power supply configuration. Hereinafter, the configuration and operation of the power supply system 10 will be described in detail.

### Configuration of the Power Supply System 10

As shown in FIG. 1, the power supply system 10 includes a first energy storage device 11, a first voltage converter 21, a second voltage converter 22, a third voltage converter 23, a fourth voltage converter 24, a second energy storage device 31, a battery sensor 32, a third energy storage device 33, a battery sensor 34, a storage unit 41, and a supply control unit 42.

The first energy storage device 11 is a secondary battery such as a lithium ion battery that supplies electric power for driving the vehicle S, and stores, for example, electric power supplied from a charging port provided in the vehicle S or electric power generated by converting regenerative energy generated by the vehicle S. The first energy storage device 11 outputs electric power at a reference voltage Vref. The reference voltage Vref is, for example, a voltage of 300 V or more and 400 V or less.

The first voltage converter 21, which is a DC-DC converter, converts a voltage (the reference voltage Vref) of the electric power output from the first energy storage device 11 to a first voltage V1 that is lower than the reference voltage. The first voltage is a voltage within the first range (20 V or more and less than 32 V), and is, for example, 24 V. The second voltage converter 22, which is a DC-DC converter, converts the reference voltage Vref to a second voltage V2 that is lower than the reference voltage Vref and lower than the first voltage V1. The second voltage is a voltage within the second range (10 V or more and less than 20 V), and is, for example, 12 V.

The third voltage converter 23, which is a DC-DC converter, further converts the voltage of the electric power converted to the first voltage V1 by the first voltage converter 21 to the second voltage V2. The fourth voltage converter 24, which is a DC-DC converter, further converts the second voltage V2 to the first voltage V1 on the basis of the electric power converted to the second voltage V2 by the second voltage converter 22 and electric power stored in the second energy storage device 31. For example, the fourth voltage converter 24 boosts the second voltage V2 to the first voltage V1 by generating electric power at the first voltage V1 on the basis of electric power at the second voltage V2 supplied from the second voltage converter 22 and electric power at the second voltage V2 supplied from the second energy storage device 31.

The second energy storage device 31 is a secondary battery such as a lead storage battery, and stores the electric power converted to the second voltage V2 by the second voltage converter 22. The battery sensor 32 is a sensor that detects the liquid temperature of the battery liquid contained in the second energy storage device 31, the current value of a current charged to the second energy storage device 31, and the current value of a current discharged from the second energy storage device 31. The battery sensor 32 may detect the voltage values corresponding to currents charged to and discharged from the second energy storage device 31. The battery sensor 32 may calculate an SOC (State Of Charge) of the second energy storage device 31 on the basis of the detected liquid temperature, current value, and voltage value. The battery sensor 32 may calculate the stage of charge of the second energy storage device 31 on the basis of (i) the detected liquid temperature of the battery liquid, (ii) the current value of the current charged to the second energy storage device 31, (iii) the current value of the current discharged from the second energy storage device 31, and (iv) the voltage value of the currents charged to and discharged from the second energy storage device 31.

The third energy storage device 33 is a secondary battery such as a lead-acid battery, and stores the electric power converted to the first voltage V1 by the first voltage converter 21. The battery sensor 34 is a sensor that detects the liquid temperature of the battery liquid contained in the third energy storage device 33, the current value of a current charged to the third energy storage device 33, and the current value of a current discharged from the third energy storage device 33. The battery sensor 34 may detect the voltage values of corresponding to currents charged to and discharged from the third energy storage device 33. The battery sensor 34 may calculate the state of charge of the third energy storage device 33 on the basis of the detected liquid temperature, current value, and voltage value. The battery sensor 34 may calculate the state of charge of the third energy storage device 33 on the basis of (i) the detected liquid temperature of the battery liquid, (ii) the current value of the current charged to the third energy storage device 33, (iii) the current value of the current discharged from the third energy storage device 33, and (iv) the voltage value of the current charged to and discharged from the third energy storage device 33.

The storage unit 41 includes, for example, a storage medium such as a ROM (Read Only Memory), a RAM (Random Access Memory), a hard disk drive (HDD), or a solid state drive (SSD). The storage unit 41 stores programs executed by the supply control unit 42 and various types of information for the supply control unit 42 to detect a power failure.

The supply control unit 42 is a processor such as a central processing unit (CPU) or an electronic control unit (ECU). The supply control unit 42 functions as the supply control unit 42 by executing the programs stored in the storage unit 41. The supply control unit 42 may be configured by a single processor, or may be configured by a plurality of processors or a combination of one or more processors and an electronic circuit.

The supply control unit 42 determines whether a power failure has occurred in the power supply system 10. The power failure includes a power failure related to electric power at the first voltage V1 and a power failure related to electric power at the second voltage V2. In the following description, as an example of the power failure, a power failure related to electric power at the first voltage V1 due to the failure of the first voltage converter 21 and a power failure related to electric power at the second voltage V2 due to the failure of the second voltage converter 22 will be described.

The supply control unit 42 acquires, for example, an input voltage and an output voltage of the third voltage converter 23 detected by a voltage sensor (not shown). For example, when the input voltage of the third voltage converter 23 is not within the first range, or when the output voltage of the third voltage converter 23 is not within the second range, which indicates voltages lower than the voltages within the first range, the supply control unit 42 determines that a power failure related to electric power at the first voltage V1 has occurred due to the failure of the first voltage converter 21. When the voltage of the electric power input to the third voltage converter 23 is lower than the first voltage V1, or the voltage converted by the third voltage converter 23 is lower than the second voltage V2, the supply control unit 42 may determine that the first voltage converter 21 has failed. Then, for example, when it is determined that the first voltage converter 21 has failed, the supply control unit 42 outputs instruction information for instructing the start of operation of the device (the first device 1b) that uses the electric power converted to the first voltage V1 by the fourth voltage converter 24.

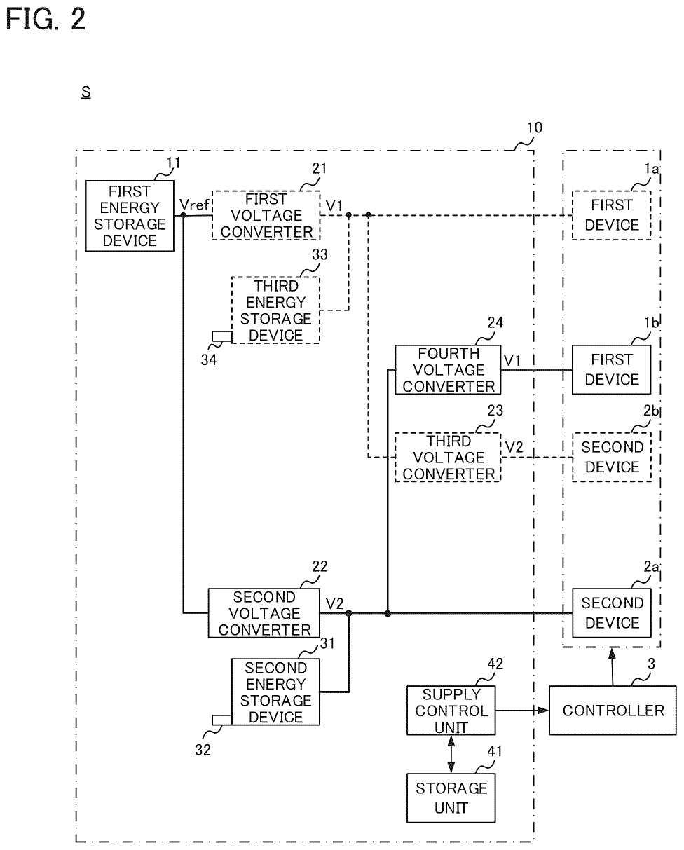

FIG. 2 is a diagram illustrating a configuration of the power supply system 10 in which the first voltage converter 21 has failed. In FIG. 2, devices and wirings to which electric power is not supplied due to the failure of the first voltage converter 21 are indicated by broken lines. As shown in FIG. 2, in the power supply system 10, due to the failure of the first voltage converter 21, electric power at the first voltage V1 is supplied from the fourth voltage converter 24. Then, the controller 3 starts the operation of the first device 1b by acquiring instruction information for instructing the start of the operation of the first device 1b from the supply control unit 42. By operating in this manner, since the controller 3 can switch from a state in which the first device 1a is used to a state in which the first device 1b is used, the vehicle S can continue operating even if the first voltage converter 21 fails.

The supply control unit 42 acquires, for example, an input voltage and an output voltage of the fourth voltage converter 24 detected by a voltage sensor (not shown). For example, when the input voltage of the fourth voltage converter 24 is not within the second range or the output voltage of the fourth voltage converter 24 is not within the first range, the supply control unit 42 determines that a power failure related to electric power at the second voltage V2 has occurred due to the failure of the second voltage converter 22. When the voltage of the electric power input to the fourth voltage converter 24 is lower than the second voltage V2, or the voltage converted by the fourth voltage converter 24 is lower than the first voltage V1, the supply control unit 42 may determine that the second voltage converter 22 has failed. Then, for example, when it is determined that the second voltage converter 22 has failed, the supply control unit 42 outputs instruction information for instructing the start of operation of the device (the second device 2b) that uses the electric power converted to the second voltage V2 by the third voltage converter 23.

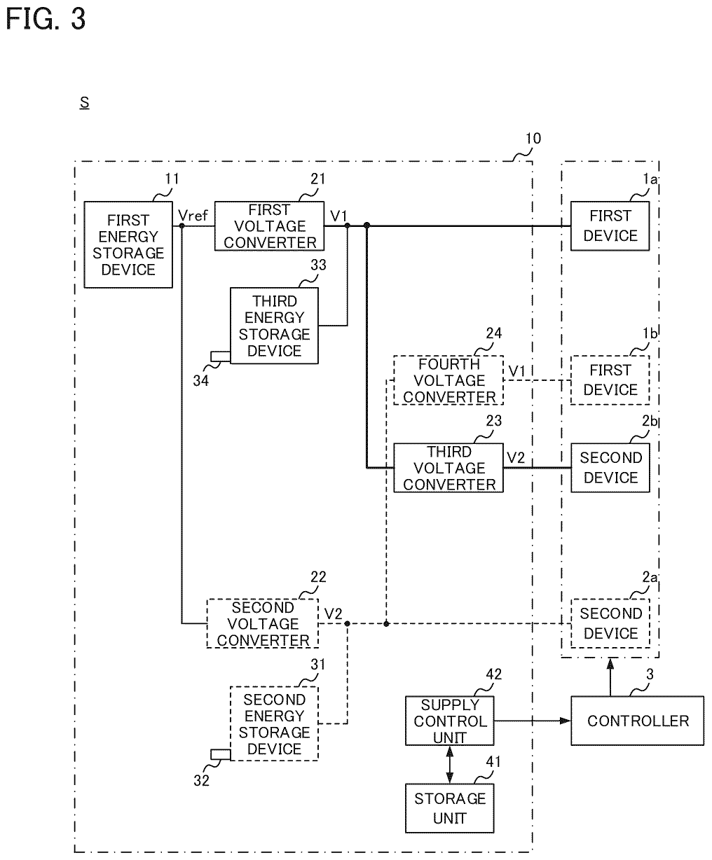

FIG. 3 is a diagram illustrating a configuration of the power supply system 10 in which the second voltage converter 22 has failed. In FIG. 3, devices and wirings to which electric power is not supplied due to the failure of the second voltage converter 22 are indicated by broken lines. As shown in FIG. 3, in the power supply system 10, due to the failure of the second voltage converter 22, electric power at the second voltage V2 is supplied from the third voltage converter 23. Then, the controller 3 starts the operation of the second device 2b by acquiring instruction information for instructing the start of operation of the second device 2b from the supply control unit 42. By operating in this manner, since the controller 3 can switch from a state in which the second device 2a is used to a state in which the second device 2b is used, the vehicle S can continue operating even if the second voltage converter 22 fails.

Since the power supply system 10 operates in the manner shown in FIGS. 2 and 3, the vehicle S can continue operating even if the first voltage converter 21 or the second voltage converter 22 fails. However, for example, since the fourth voltage converter 24 outputs electric power at the first voltage V1 using the electric power charged by the second energy storage device 31, the output voltage may be lower than the first voltage V1 when the charge amount of the second energy storage device 31 decreases. In this case, the vehicle S cannot continue operating.

Therefore, for example, when at least one of the state of charge of the second energy storage device 31 and the state of charge of the third energy storage device 33 is less than a predetermined state of charge, the supply control unit 42 outputs instruction information instructing the disabling of autonomous driving of the vehicle S, which includes the power supply system 10. The predetermined state of charge is, for example, 75% and is stored in the storage unit 41. For example, the supply control unit 42 estimates the state of charge of the second energy storage device 31 on the basis of the charging current value and discharging current value detected by the battery sensor 32, and estimates the state of charge of the third energy storage device 33 on the basis of the charging current value and discharging current value detected by the battery sensor 34. The supply control unit 42 may acquire the state of charge of the second energy storage device 31 from the battery sensor 32, and acquire the state of charge of the third energy storage device 33 from the battery sensor 34. By operating in this manner, the controller 3 can switch the vehicle S to manual driving or bring the vehicle S to a stop on the basis of an instruction disabling autonomous driving included in the instruction information.

The supply control unit 42 acquires, for example, the liquid temperature of the battery liquid contained in the second energy storage device 31 detected by the battery sensor 32 and the liquid temperature of the battery liquid contained in the third energy storage device 31 detected by the battery sensor 34. When at least one of the acquired liquid temperatures is lower than a predetermined liquid temperature, the supply control unit 42 may output instruction information instructing the disabling of autonomous driving of the vehicle S, which includes the power supply system 10. The predetermined liquid temperature is, for example, a liquid temperature of 0° C. or lower, and is stored in the storage unit 41. By operating in this manner, the supply control unit 42 can prevent the vehicle S from continuing to operate in a state where the amount of dischargeable power has decreased, since the lower the liquid temperature of the battery liquid, the smaller the amount of dischargeable power of the energy storage device becomes.

In the vehicle S illustrated in FIG. 1, the controller 3 switches to use the first device 1b or the second device 2b on the basis of the instruction information output by the power supply system 10 as a result of detecting a failure. Therefore, in the vehicle S illustrated in FIG. 1, during a time period from the detection of the failure to the switching of the device, the voltage supplied to the first device 1a or the second device 2a may decrease, and as a result, both of the first devices 1a and 1b or both of the second devices 2a and 2b may become inoperative.

To address this, the power supply system 10 may be configured to supply the first device 1b and the second device 2b with electric power at a voltage lower than the voltage before the occurrence of the power failure after the occurrence of the power failure. For example, the power supply system 10 switches from a state in which electric power at a first voltage greater than the minimum value of the first range is supplied to the first device 1b to a state in which electric power at a fourth voltage that is greater than the minimum value of the first range but lower than the first voltage is supplied to the first device 1b. The first range is a range of voltages at which the first device 1b can operate. For example, the power supply system 10 switches from a state in which electric power at a second voltage that is greater than the minimum value of the second range is supplied to the second device 2b to a state in which electric power at a third voltage that is greater than the minimum value of the second range but lower than the second voltage is supplied to the second device 2b. The second range is a range of voltages at which the second device 2b can operate.

Since the power supply system 10 is configured in this manner, in the vehicle S, switching can be performed so that the first device 1b and the second device 2b operate on the basis of the voltage of the supplied electric power. That is, in the vehicle S, since the first device 1b and the second device 2b start operating in response to a change in the voltage of the input electric power, the devices can be switched without the controller 3 needing to perform switching control on the basis of the instruction information. As a result, since it is not necessary for the power supply system 10 to detect a failure or for the controller 3 to switch the devices on the basis of the instruction information, the vehicle S can shorten the time required to switch the devices. Therefore, in the vehicle S, it is possible to continue operating the first device 1a or the first device 1b, and the second device 2a or the second device 2b.

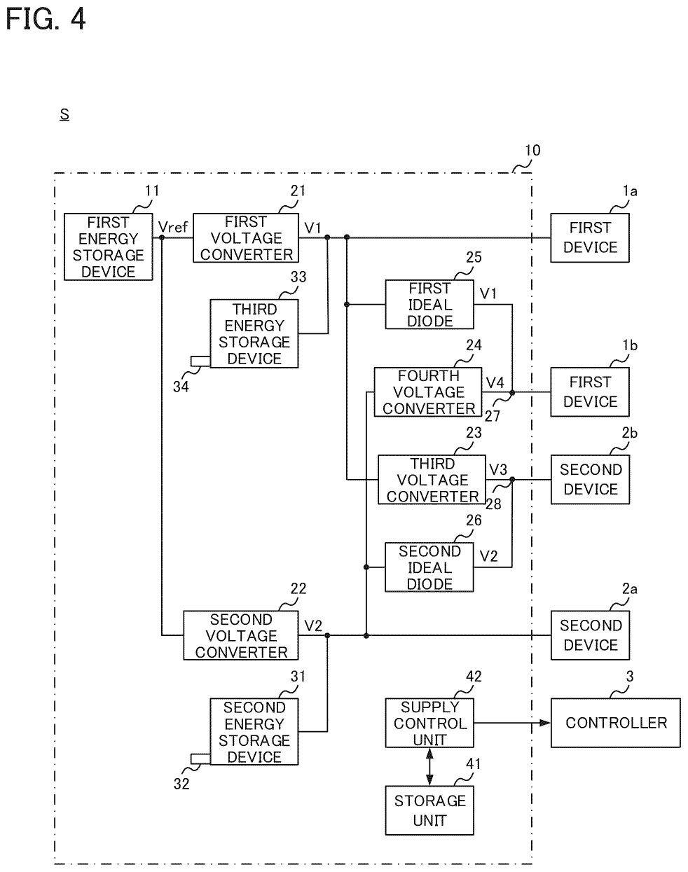

FIG. 4 is a diagram illustrating the vehicle S that changes the voltage of electric power to be supplied in response to a power failure. The power supply system 10 shown in FIG. 4 differs from the power supply system 10 shown in FIG. 1 in that it has a first ideal diode 25 and a second ideal diode 26, and is otherwise the same. FIG. 4 also shows a first contact portion 27 that connects an output terminal of the first ideal diode 25 and an output terminal of the fourth voltage converter 24, and a second contact portion 28 that connects an output terminal of the second ideal diode 26 and an output terminal of the third voltage converter 23.

The first ideal diode 25 is a circuit that outputs the electric power, which has been converted to the first voltage V1 by the first voltage converter 21, in one direction (i.e., a direction in which the electric power is output toward the first device 1b) at a predetermined forward voltage. The predetermined forward voltage is, for example, 0 V. The second ideal diode 26 is a circuit that outputs the electric power, which has been converted to the second voltage V2 by the second voltage converter 22, in one direction (i.e., a direction in which the electric power is output toward the second device 2b) at the predetermined forward voltage.

Then, as shown in FIG. 4, the third voltage converter 23 converts the voltage of the electric power, which has been converted to the first voltage V1 by the first voltage converter 21, to a third voltage V3 that is lower than the second voltage V2. The third voltage V3 is, for example, 12 V when the second voltage V2 is 15 V. The fourth voltage converter 24 converts the voltage of the input electric power to a fourth voltage V4 that is lower than the first voltage V1 on the basis of the electric power, which has been converted to the second voltage V2 and the electric power stored in the second energy storage device 31. The fourth voltage V4 is, for example, 24 V when the first voltage V1 is 27 V.

In other words, the third voltage converter 23 converts the voltage of the electric power converted to the first voltage within the first range by the first voltage converter 21 into a third voltage that is within the second range, which indicates voltages lower than the voltages within the first range, and is lower than the second voltage within the second range. The fourth voltage converter 24 converts the voltage of the input electric power to a fourth voltage that is within the first range and is lower than the first voltage within the first range, on the basis of the electric power converted to the second voltage within the second range and the electric power stored in the second energy storage device 31. As described above, when the first voltage converter 21 and the second voltage converter 22 do not fail, the power supply system 10 supplies the electric power at the first voltage V1 to the first devices 1a and 1b, and supplies the electric power at the second voltage V2 to the second devices 2a and 2b.

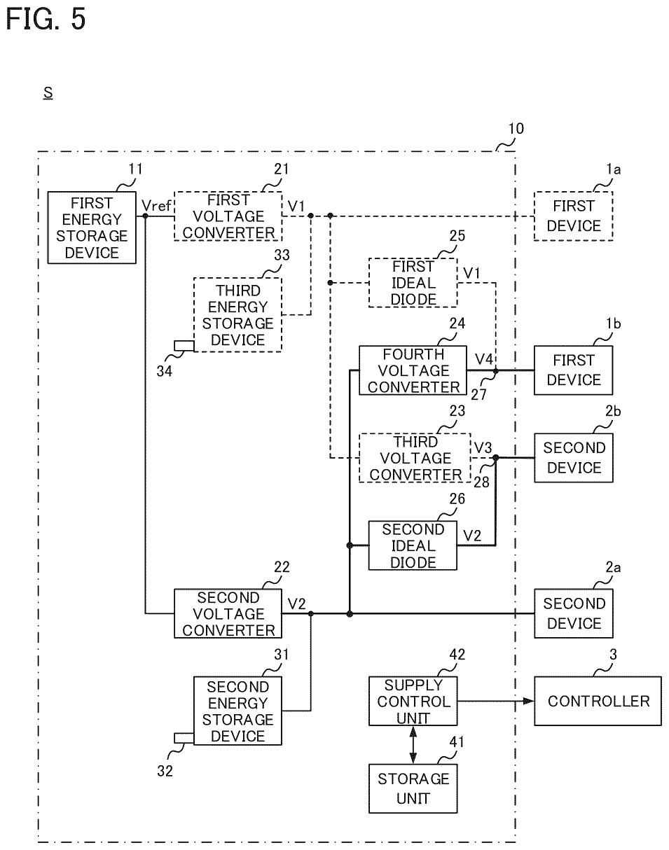

When the first voltage converter 21 fails, the power supply system 10 supplies electric power at the fourth voltage V4 to the first device 1b. FIG. 5 is a diagram illustrating a configuration of the power supply system 10 in which the first voltage converter 21 illustrated in FIG. 4 has failed. In FIG. 5, devices and wirings to which electric power is not supplied due to the failure of the first voltage converter 21 are indicated by broken lines. As shown in FIG. 5, in the power supply system 10, due to the failure of the second voltage converter 22, electric power supplied to the first device 1b is switched from the electric power at the first voltage V1 output by the first ideal diode 25 to the electric power at the fourth voltage V4 output by the fourth voltage converter 24.

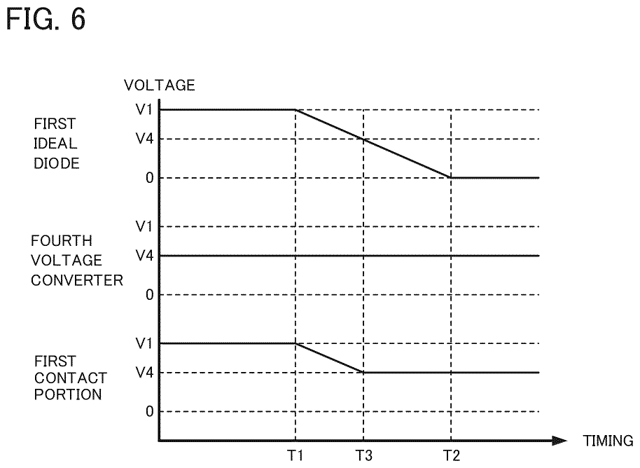

FIG. 6 is a diagram illustrating a voltage of electric power supplied to the first device 1b. The horizontal axis of FIG. 6 indicates timing, and the vertical axis of FIG. 6 indicates an output voltage of the first ideal diode 25, the output voltage of the fourth voltage converter 24, and an output voltage of the first contact portion 27 (i.e., the voltage of the electric power supplied to the first device 1b). A timing T1 shown in FIG. 6 is a timing at which the first voltage converter 21 fails. From the timing T1 to a timing T2, the output voltage of the first ideal diode 25 decreases from the first voltage V1 to 0 V due to the failure of the first voltage converter 21. On the other hand, the output voltage of the fourth voltage converter 24 maintains the fourth voltage V4 because the second voltage converter 22 has not failed. As described above, the output voltage of the first contact portion 27 decreases from the first voltage V1 to the fourth voltage V4 from the timing T1 to a timing T3, and maintains the fourth voltage V4 after the timing T3.

Since the power supply system 10 operates in this manner, although the voltage of the electric power supplied to the first device 1b changes from the first voltage V1 to the fourth voltage V4, since the fourth voltage V4 is a voltage within the first range, the first device 1b can operate. The first device 1b can operate in place of the first device 1a on the basis of the change from the first voltage V1 to the fourth voltage V4. As a result, in the vehicle S, even if the first voltage converter 21 fails, the first device 1b can begin operation in place of the first device 1a before both of the first devices 1a and 1b become inoperative.

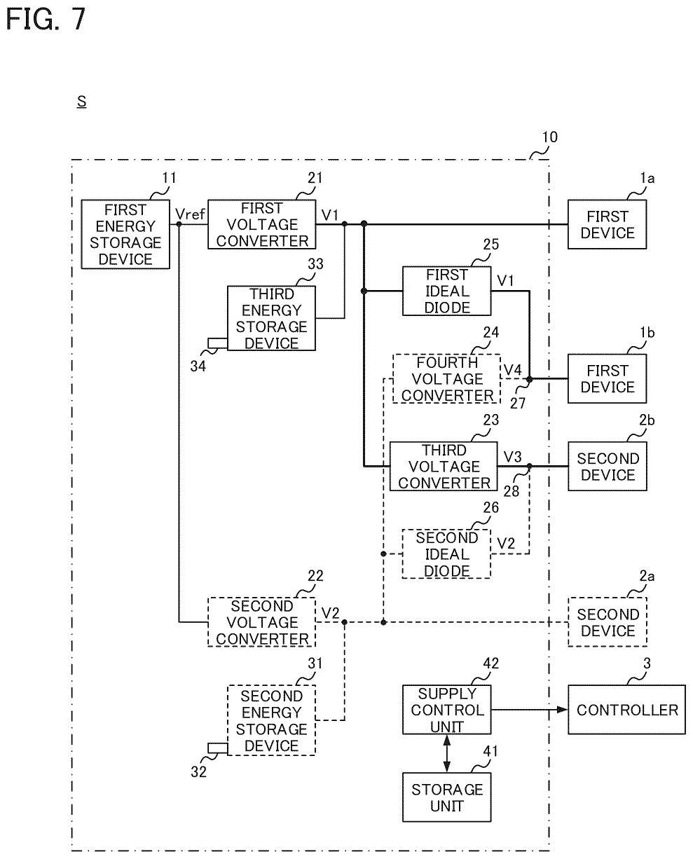

In a case where the second voltage converter 22 fails, the power supply system 10 supplies electric power at the third voltage V3 to the second device 2b. FIG. 7 is a diagram illustrating a configuration of the power supply system 10 in which the second voltage converter 22 illustrated in FIG. 4 has failed. In FIG. 7, devices and wirings to which electric power is not supplied due to the failure of the second voltage converter 22 are indicated by broken lines. As shown in FIG. 7, in the power supply system 10, due to the failure of the second voltage converter 22, electric power supplied to the second device 2b is switched from the electric power at the second voltage V2 output by the second ideal diode 26 to the electric power at the third voltage V3 output by the third voltage converter 23.

Since the power supply system 10 operates in this manner, although the voltage of the electric power supplied to the second device 2b changes from the second voltage V2 to the third voltage V3, since the third voltage V3 is a voltage within the second range, the second device 2b can operate. The second device 2b can operate in place of the second device 2a on the basis of the change from the second voltage V2 to the third voltage V3. As a result, in the vehicle S, even if the second voltage converter 22 fails, the second device 2b can begin operation in place of the second device 2a before both of the second devices 2a and 2b become inoperative.

### Effects of the Power Supply System 10

As described above, the power supply system 10 includes: the first energy storage device 11 that outputs electric power at the reference voltage Vref; the first voltage converter 21 that converts the reference voltage Vref to the first voltage V1 lower than the reference voltage Vref; the second voltage converter 22 that converts the reference voltage Vref to the second voltage V2 that is lower than the reference voltage Vref and lower than the first voltage V1; the second energy storage device 31 that stores the electric power converted by the second voltage converter 22; the third voltage converter 23 that further converts the first voltage output from the first voltage converter 21 into the second voltage V2; and a fourth voltage converter 24 that further converts the second voltage V2 to the first voltage V1 on the basis of the electric power converted to the second voltage V2 by the second voltage converter 22 and the electric power stored in the second energy storage device 31.

With this configuration, even if a failure related to the electric power at the second voltage V2 occurs, the power supply system 10 can supply electric power at the first voltage V1 even if a failure related to the electric power at the first voltage V1 occurs and can supply electric power at the second voltage V2 without providing redundancy in the power supply. As a result, the power supply system 10 can supply the electric power at the first voltage V1 and the electric power at the second voltage V2 while reducing the weight and cost of the power supply device.

Furthermore, since the power supply system 10 includes the first ideal diode 25 and the second ideal diode 26 illustrated in FIG. 4, the electric power at the fourth voltage V4 can be supplied to the first device 1b, and the electric power at the third voltage V3 can also be supplied to the second device 2b. As a result, since the first device 1b and the second device 2b can switch to operate themselves on the basis of a change in voltage, the switching time at the time of a power failure can be shortened. Furthermore, in a case where a power supply failure does not occur, by supplying electric power from the first ideal diode 25 and the second ideal diode 26, loads of the third voltage converter 23 and the fourth voltage converter 24 can be reduced, and therefore the power supply system 10 can suppress power consumption.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A power supply system comprising:
a first energy storage device that outputs electric power at a reference voltage;
a first voltage converter that converts the reference voltage to a first voltage that is lower than the reference voltage;
a second voltage converter that converts the reference voltage to a second voltage that is lower than both the reference voltage and the first voltage;
a second energy storage device that stores the electric power converted by the second voltage converter;
a third voltage converter that further converts the first voltage output from the first voltage converter to the second voltage; and
a fourth voltage converter that further converts the second voltage to the first voltage on the basis of the electric power converted to the second voltage by the second voltage converter and the electric power stored in the second energy storage device.

2. The power supply system according to claim 1, further comprising:
a supply control unit that outputs instruction information for instructing start of operation of a device that uses the electric power converted to the first voltage by the fourth voltage converter when it is determined that the first voltage converter has failed, and outputs instruction information for instructing start of operation of a device that uses the electric power converted to the second voltage by the third voltage converter when it is determined that the second voltage converter has failed.

3. The power supply system according to claim 2, wherein the supply control unit determines that the first voltage converter has failed when voltage of the electric power input to the third voltage converter is lower than the first voltage or the voltage converted by the third voltage converter is lower than the second voltage, and determines that the second voltage converter has failed when voltage of the electric power input to the fourth voltage converter is lower than the second voltage or the voltage converted by the fourth voltage converter is lower than the first voltage.

4. The power supply system according to claim 2, further comprising:
a third energy storage device that stores the electric power converted by the first voltage converter, wherein the supply control unit outputs instruction information instructing disabling of autonomous driving of a vehicle, which includes the electric power supply system, when at least one of a state of charge of the second energy storage device and a state of charge of the third energy storage device is less than a predetermined state of charge.

5. The power supply system according to claim 2, further comprising:
a third energy storage device that stores the electric power converted by the first voltage converter, wherein the supply control unit outputs instruction information instructing disabling of autonomous driving of a vehicle, which includes the power supply system, when at least one of a liquid temperature of battery liquid contained in the second energy storage device and a liquid temperature of battery liquid contained in the third energy storage device is lower than a predetermined liquid temperature.

6. The power supply system according to claim 1, further comprising:
a first ideal diode that outputs the electric power, which has been converted to the first voltage by the first voltage converter, in one direction at a predetermined forward voltage;
a second ideal diode that outputs the electric power, which has been converted to the second voltage by the second voltage converter, in one direction at a predetermined forward voltage;
a first contact portion that connects an output terminal of the first ideal diode and an output terminal of the fourth voltage converter; and
a second contact portion that connects an output terminal of the second ideal diode and an output terminal of the third voltage converter.

7. The power supply system according to claim 6, wherein the third voltage converter converts the first voltage output from the first voltage converter, to a third voltage that is lower than the second voltage, and
the fourth voltage converter converts voltage of an input electric power to a fourth voltage that is lower than the first voltage on the basis of the electric power, which has been converted to the second voltage, and the electric power stored in the second energy storage device.

8. The power supply system according to claim 6, wherein the third voltage converter converts voltage, obtained by conversion of the electric power by the first voltage converter to a voltage within a first range, into a third voltage that is within a second range, which indicates voltages lower than voltages within the first range, and is lower than the second voltage within the second range, and
the fourth voltage converter converts voltage of an input electric power to a fourth voltage that is within the first range and is lower than the first voltage within the first range, on the basis of the electric power converted to the second voltage within the second range and the electric power stored in the second energy storage device.

9. The power supply system according to claim 2, wherein the supply control unit determines that a power failure related to electric power at the first voltage has occurred due to a failure of the first voltage converter when input voltage of the third voltage converter is not within a first range or when output voltage of the third voltage converter is not within a second range, which indicates voltages lower than voltages within the first range.

10. The power supply system according to claim 9, wherein the supply control unit determines that a power failure related to electric power at the second voltage has occurred due to a failure of the second voltage converter when input voltage of the fourth voltage converter is not within the second range or output voltage of the fourth voltage converter is not within the first range.
